(19) United States
(12) Patent Application Publication
(10) Pub. No.: US 2011/0038514 A1
(43) Pub. Date: Feb. 17, 2011

(54) METHOD FOR CHECKING A PREPARATION OF A PREPARED TOOTH WITH CAD METHODS

(76) Inventor: Paul Weigl, Frankfurt (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/450,115

(22) PCT Filed: Mar. 13, 2008
(86) PCT No.: PCT/EP2008/052987

§ 371 Date: Jan. 12, 2010

(30) Foreign Application Priority Data
Mar. 13, 2007 (DE) 10 2007 012 584.6

(51) Int. Cl. G06K 9/00

(52) U.S. Cl. 382/128

(57) ABSTRACT

The invention relates to a method for checking a preparation (14) of a prepared tooth (13) using CAD methods and utilizing a first 3D image (11) of the prepared tooth (13) including at least a portion of its adjacent tooth (2, 3). The subregions (24, 25, 53, 55, 78) of the preparation (14, 110, 130, 140, 152) are marked whose distances (31.2, 32.2, 51, 75) from the adjacent teeth (2, 3), from the desired preparation (5) and/or from a gingival surface (76) and/or the angle (60) thereof and/or the roughness thereof are outside the limits (54, 56, 77, 79) of a respective tolerance range (52).

### BACKGROUND OF THE INVENTION

The invention relates to a method for checking a preparation of a prepared tooth or a prepared implant using CAD methods, using a first 3D image of the prepared tooth including at least a portion of its adjacent tooth.

### PRIOR ART

In dentistry there exist two different methods for the restoration of teeth with hard substance defects. The defects—usually carious lesions—are either treated with plastic filling material directly on the tooth. Following curing and finishing of the filling materials (for example, surface polishing) no further therapeutic measure is necessary.

These directly produced restorations differ from the indirectly produced—or in other words extraorally produced—therapeutic agents. These include small ceramic chips, inlays, onlays, veneers and crowns. For the replacement of whole teeth use can be made of bridges whose pillar teeth are prepared as for the accommodation of crowns. The extraoral therapeutic methods require preparation, which can be effected either conventionally using impression compounds or by using scanners intraorally. The finished therapeutic agents are attached to the prepared teeth using special cements.

Since the materials of such therapeutic agents—metals, ceramics, composites, etc.—are not plastic under clinical conditions, certain 3D shapes of a preparation are obligatory. Tapering preparation walls of a preparation make it possible to insert the restoration into the tooth or place it thereon and define the axis of insertion. If a preparation wall or an area does not conform to this axis of insertion, there is no possibility of positioning the therapeutic agent to give a precise fit on the tooth and fix it with dental cement. Thus each correct preparation has an axis of insertion for accommodation of an extraorally fabricated restoration, which is defined by the movement vector of the restoration during integration. In the case of solid crowns the axis of insertion is usually selected so as to be parallel to the axis of the tooth, in order to keep down the loss of hard substance when designing a slightly tapered cone. In the case of inlays, the cavity walls must be prepared with slightly divergence. The prepared tooth forms the matrix and the inlay is the corresponding positive patrix for the cavity.

The conicity or the divergence of opposing preparation walls is determined relatively to the axis of insertion. Excessive conicity or divergence of opposing preparation surfaces causes unnecessary loss of material and thus an increased risk of devitalizing the tooth. Additionally, the tooth is weakened to masticatory forces. If mechanically retentive fixing materials are used, for example zinc phosphate cement, there is lessening of the adhesive force of such fixing cements as the conicity or divergence increases. Especially metallic restorations have thereby insufficient adhesiveness relative to the tooth and decementation shortly follows. Contrariwise,—in the case of opposing surfaces that are too steep or almost parallel—integration is hampered or made impossible by reason of the high frictional resistance between the tooth and the restoration. If preparation surfaces are present which represent an undercut relative to the axis of insertion, the corresponding surfaces of the restoration can no longer be accurately fitted or show a thin cement gap. But rather, for example in the case of a solid crown, it will be impossible to design an accurately fitting crown border. Thus, depending on size, undercuts count as clear faulty sites or errors in a preparation for accommodation of an extraorally fabricated restoration.

Another demand imposed on a preparation is derived from the limitation of extra-axial shaping methods (casting, sintering, compression molding, grinding, etc.). The restoration border can be prepared as a wavy structure only to a certain degree, and a jagged border cannot be reproducibly produced complementary to preparation requirements. The same applies to the roughness of the preparation surface directly adjoining the preparation border. An exactly fitting transition between the restoration material and the intact surface of the tooth is a prerequisite for the avoidance of secondary caries and is thus essential for sustained therapeutic success. Thus a smooth preparation outline, if possible not wavy but rectilinear, and a smooth surface of the preparation in the immediate vicinity of the preparation border, count as the main requirements of a preparation for the accommodation of indirectly fabricated therapeutic agents. Differentiation of the form of a preparation border is additionally dependent on the specific material properties and the relevant shaping method.

A third demand on a preparation is defined by the strength and/or optical properties of the restoration material. Both parameters require a certain material layer thickness to withstand the high masticatory loads on the one hand and/or to achieve an attractive esthetic appearance of the restoration on the other. In other words, a minimum removal of dental hard substance (enamel/dentin) is necessary in order to make it possible to satisfy the above criterion regarding a minimum material layer thickness. In dentistry there is a ubiquitous conflict of aims which has very serious medical consequences and relates to the removal of neither too little nor too much dental hard substance when forming a preparation. Above all, the unnecessary removal of too much hard substance endangers both the vitality of the tooth and the mechanical stability of the residual tooth substance. Mortification of the pulp tissue (dental pulp) constitutes a serious complication which usually calls for endodontic treatment (root canal treatment) and the subsequent production of the restoration from scratch. Should the endodontic treatment fail, the tooth becomes useless and must be removed. The same fate applies to necrotic teeth which are not subjected to endodontic treatment on account of the very high cost of such treatment.

Another demand to be considered regarding a preparation is a consequence of the necessity to ensure that the preparation border does not contact the adjacent tooth, i.e. must be at a minimum distance therefrom. Otherwise correct insertion of the restoration will be hampered or not possible.

Thus an objective method of checking a preparation is of high clinical significance regarding the fitting accuracy and the longevity of the therapeutic agent used on the prepared tooth or the prepared implant, such as an inlay, an onlay, a veneer, or a crown.

The prior art includes a number of methods for checking the preparation of a prepared tooth.

DE 197 14 526 A1 discloses a checking system for assessment of preparations of teeth, tooth restorations or dental prosthetic items. The prepared tooth is scanned by a measuring device, and an evaluation device assesses the preparation with reference to the specified target information and also the measured information supplied by the measuring device. This checking system is used for training purposes, in which prepared teeth in a training model are assessed. For this purpose, the teeth can be recorded in the training model or they can be removed from the training model for recording purposes. The assessment is carried out by superimposing a desired state of the preparation on the measured information provided by the measuring device.

A drawback of this checking system is that for assessment the measured preparation is superimposed on a template showing a desired preparation. This requires a data base containing a plurality of templates for different types of preparation of different sizes. Such assessment is meaningful for training purposes since teeth of identical size are prepared in standardized training models and the desired preparation is known. This method is unsuitable for the assessment of preparations of real teeth, because real teeth differ in shape and size and the optimal preparation varies individually for each clinical case, whilst a plurality of preparation forms may be clinically indicated within a tolerance range. In particular, defect-oriented types of preparation—such as the inlay preparation—are highly diverse as regards their expanse and their preparation border profile. For this reason, assessment based on specified criteria is a more objective checking method.

Moreover, when the desired preparation and the measured information are superimposed, superimposition errors may lead to incorrect assessment of the preparation.

Another drawback is that the preparation is not checked for its position relative to the antagonistic teeth and to the adjacent teeth, but exclusively for shape.

The conventional method used world-wide is based on visual assessment of the preparation directly in the patient's mouth. The dental mirror and dental probe serve as aids for achieving a purely subjective assessment of the preparation on the basis of experience. Magnifying spectacles or an OP microscope improve recognition of compromise-prone surfaces of a prepared tooth. Two-dimensional photographs of the preparations are being increasingly used as an alternative to the aforementioned optical aids. In the case of poor conditions for visual examination, an impression of the tooth can be made, and the preparation then evaluated in the form of its negative (impression) or its positive (cast of the impression, jaw model). In the latter case, a parallelometer may be used for the objective measurement of the preparation angle and of undercuts that may be present. If flawed regions of the preparation are discovered and the attempt made to eliminate the same by regrinding the tooth, another impression is necessary for rechecking the preparation or for fabrication of the dental restoration on a jaw model. The considerable additional time expenditure, the consequent enormous cost, and the increased load on the patient caused by the repeated impressions results in the method for making impressions for checking a preparation being used only extremely rarely in dental practices or dental clinics.

However, it is precisely this unfavorable method involving the creation of an impression of the preparation that forms the basis for all known novel CAD-based methods for evaluation of preparations. The impression is cast in gypsum. There then follows a cost-intensive production of a component-separated jaw model, usually of gypsum, which is necessary for three-dimensional scanning of the prepared tooth and its close neighboring structures (adjacent teeth, antagonistic teeth, dental therapeutic agents, etc.) individually in an extraoral scanner. The time passing between molding the tooth and offering a 3D data set for further processing using CAD-evaluation software is longer than the period of action of a local anesthetic. Any necessary correction of the preparation would call for a second dose of local anesthetic or for an extra treatment appointment. Both represent an unreasonable load on the patient and on the dentist carrying out routine treatment.

This set of problems involving enormous time expenditure for CAD-based checking of a preparation following impression-making is additionally intensified by interactive evaluation of the data set.

Currently commercially available CAD-based software for checking preparations reads the 3D data set produced by an extraoral scanner and visualizes it on the video monitor. The software user selects a series of routines for the purpose of measuring the preparations in locally restricted regions which have themselves been selected. This interactive measurement of the preparation takes much time due to this procedure. There is additionally the risk of unsatisfactory regions of the preparation remaining undiscovered on account of the user-dependent selection of the evaluated areas of the preparation.

One approach to solving the above problems involves the use of a dental handpiece during preparation measured three-dimensionally in real time. In this case, the tooth and its neighboring structures are three-dimensionally scanned prior to commencement of the preparation. Over a reference point within the measured 3D data set and freely selectable by the dentist, the position of the grinding element clamped in the handpiece is correlated and the motion thereof effected by the dentist's hand is also three-dimensionally recorded. A CAD program now calculates the removal of substance from the tooth virtually in real time.

The use of this method on a patient is, however, greatly restricted on account of movements of the head and/or the lower jaw, and the process is thus extremely hazardous. Movements of the head/lower jaw and thus of the upper/lower jaw teeth must likewise be registered in real time, in order to make it possible to balance out the motion of the handpiece, i.e. grinding element, against the motion of the tooth such that always the real position of the grinding element relative to the tooth is precisely virtually imaged.

However, the registration of head/lower jaw movements, for example by simply sticking reference points to the skin, is not possible to the required degree of precision. Fixed anchorage of the reference points on the teeth is very time-consuming and problematical, since it additionally hinders the rather tight access to the tooth to be prepared. Anchorages fixed in scull bones or facial bones are out of the question, since the risk-benefit ratio forbids use thereof.

All of the aforementioned drawbacks of prior CAD-based methods for checking preparations have led exclusively to the use thereof for training students or dentists, this mainly being carried out on phantom heads.

If plastic teeth are to be prepared during training, they can be readily removed from the phantom head and scanned in an extraoral scanner. However, there are no neighboring structures to provide a complete assessment of the preparation, which structures can in turn only be used for assessment with the aid of the elaborate method of making an impression and fabricating a model.

It is an object of the present invention to provide a method for checking a preparation of a prepared tooth making it possible to objectively judge, in a simple and time-saving manner, whether the preparation has been carried out so as to comply with desired or necessary presettings and to satisfy the clinical and material-specific demands, as a result of which an extraorally fabricated therapeutic agent can be accurately fitted to the prepared tooth and bonded thereto.

### SUMMARY OF THE INVENTION

This object is achieved by the present invention.

In the present invention, the method for checking a preparation of at least one prepared tooth or at least one prepared implant using CAD methods involves the use of a first 3D image of the prepared tooth or prepared implant including at least a portion of an adjacent tooth. A preparation border of the preparation is detected. From the first 3D image, distances of the preparation from the adjacent teeth and/or from a desired preparation and/or from a gingiva surface and/or an angle of a preparation wall and/or the roughness of the preparation are determined. Those subregions of the preparation are marked, whose distances from the adjacent teeth, from the desired preparation and/or from a gingiva surface and/or whose angle and/or whose roughness value are outside the limits of a respective tolerance range. Moreover, those preparation border areas are marked which adjoin the preparation border, and whose waviness is outside a tolerance range.

The preparation can be created on a tooth or a dental implant. The checking method of the invention can be carried out directly in the dental practice immediately after the preparation has been made. By this means, the preparation and any possibly necessary corrections to the preparation can be carried out during a single dental appointment.

The first image depicts the prepared tooth including at least portions of its adjacent teeth.

The preparation border is the boundary of the preparation between an uncarved surface of the tooth and a carved surface of the tooth. Preparation border areas adjoining the preparation border are inspected for waviness. Preparation border areas whose waviness exceeds a fixed tolerance range are marked. By this means a precisely fitting transition between the material of a therapeutic agent and the healthy, uncarved surface of the tooth is ensured, which serves to obviate secondary caries. Depending on the fabrication method, a restoration border of the therapeutic agent can only be produced up to a certain degree of waviness. A preparation border exhibiting jags, for example, is not capable of complementary reproducibility.

The scanned preparation is compared with a desired preparation in the form of a chamfer, an inwardly gorged shoulder and a bevel for a feather-edge, and subregions showing deviations that lie outside a defined tolerance range are marked.

The marked subregions consequently exhibit the aforementioned parameters which lie outside the limits of a respective tolerance range and are thus unsuitable for attachment of a therapeutic agent to said preparation on account of poor stability, poor adhesiveness and/or poor material layer dependent optical properties of the restoration. The marked subregions can in the case of insufficient removal of dental hard substance be corrected by further removal thereof in order to place said parameters inside the respective tolerance ranges.

Subregions of the preparation are marked which, relative to the axis of insertion, are prepared either excessively tapered or excessively divergent, excessively steep to being parallel, or have undercuts, since these subregions exhibit angles of the preparation walls and distances from a desired preparation which lie outside the tolerance range.

The method of the invention for checking preparations can be used during dental treatment, in order to guarantee the quality of the tooth restorations fabricated. Another possible use of the method is the monitoring of the quality of 3D images of preparations from a data library. The data acquired by the checking method of the invention can be digitally stored as a confirmatory test of the quality the preparation created, for documentation purposes. Moreover, the method of the invention can be used for training purposes by checking the preparations made by trainees in tooth models for accuracy thereof. By this means the trainee can independently, objectively, and without the assistance of training staff recheck the created preparation for quality and correct it in the marked subregions.

One advantage is that the fit of the restoration is improved by a corrected preparation so that the longevity of the dental prosthetic item is prolonged.

Another advantage is that the dentist, when conducting a post-treatment examination, is able to call on the data of the check-out for the corresponding preparation from the data library.

Moreover, the evaluation of said parameters allows, unlike a mere comparison with a desired preparation form, for a more objective assessment of a preparation.

Advantageously, use can be made of a second 3D image of an impression of the opposing dentition at the site of the prepared tooth or the prepared implant and at least a portion of an adjacent tooth for checking the preparation. The first 3D image is brought into register with the second 3D image. From the correlated 3D images, a first distance of the preparation of the prepared tooth from the opposing dentition is determined. Those subregions of the preparation are marked whose first distance from the opposing dentition is outside the limits of a tolerance range.

The second image records the dentition or the therapeutic agents used in the opposing dentition at the site of the prepared tooth. The impression of the opposing jaw can be made using a dynamic interocclusal registration (impression compound), which is placed on the prepared tooth without covering the adjacent teeth. Distinctive points and structures on the adjacent teeth can then be used for correlation of the first 3D image including the prepared tooth with the second 3D image including an impression of the antagonistic teeth.

The spatial association of the antagonistic teeth or the dental therapeutic agent in the dynamic occlusion of the patient is determined by means of correlation of the first and second 3D images.

The impression of the opposing dentition at the position of the prepared tooth is produced by placing the impression compound at the site of the prepared tooth and allowing the patient to bite on the molding compound so that the teeth adjacent to the prepared tooth come into contact with the respective opposing teeth and an impression of the opposing dentition in the region of the prepared tooth is produced in the molding compound.

Subregions of the preparation are marked whose distance from the opposing dentition (antagonistic teeth) is outside the tolerance range. A distance too short would lead to a restoration having a small material thickness, which would not achieve the necessary stability and/or the desired esthetic appearance.

Advantageously, a third 3D image of the tooth to be prepared can be created prior to preparation to include at least a portion of an adjacent tooth, which image can be used for checking the preparation. The first 3D image is brought into register with the third 3D image. From the correlated 3D images, a distance of the preparation from the surface of the tooth prior to preparation is determined normal to the surface of the preparation. Those subregions of the preparation are marked whose distance from the tooth prior to preparation is outside the limits of a tolerance range.

By this means, the distance of the preparation from the tooth or implant prior to preparation can be determined, and those subregions are marked whose distance is outside the permissible tolerance range. The correlation of the third with the first 3D image is carried out in the same way as the correlation of the second with the first 3D image implementing at least three coincident distinctive points.

Advantageously, the preparation can be configured for the provision of a solid crown, an onlay, an inlay, a veneer or a bridge.

The preparation to be checked can consequently serve for the use of extraorally fabricated therapeutic agents, such as solid crowns, inlays, onlays, anterior tooth veneers and bridges. Below, the preparations are referred to as full crown preparations, onlay preparations, inlay preparations, veneer preparations, and bridge preparations.

Advantageously, the subregions of the preparation lying outside the limits of a relevant tolerance range can be automatically marked by computer.

By this means, the checking method of the invention can be carried out fully automatically by marking and displaying subregions whose said measured parameters lie outside the respective tolerance ranges without the user taking any action.

Advantageously, the first, the second, and/or the third 3D image can be created intraorally in an oral cavity of a patient or a phantom head.

In this way, the prepared tooth can be imaged in the phantom head without having to remove the same from the phantom head.

Advantageously, the waviness of preparation border areas adjoining the preparation border can be determined and those preparation border areas are marked whose preparation border has jags.

By this means, preparation border areas are marked which are unsuitable for the precise insertion of a therapeutic agent, such as a crown, relatively to the preparation border.

Advantageously, the preparation can have an axis of insertion. A first distance of an occlusal surface of the preparation from the impression surface of the opposing dentition along the axis of insertion can be determined, and subregions can be marked whose first distance is outside a tolerance range centered about a preset first desired distance.

The axis of insertion represents a connecting axis between the preparation and the crown. This axis of insertion can be defined as an axis of symmetry relative to the preparation walls of the preparation by determining the axis of insertion via the sum vector of single vectors which run parallel to the determined preparation walls.

By this means it is possible to find which subregion has a first distance outside the fixed tolerance range. A first distance which is too short leads to poor stability of the crown, because the crown, particularly when stressed laterally, can be loosened by the preparation. A first distance which is too long results in the upper occlusal surface of the crown having to be produced with thin walls which are sooner fractured under load.

The first distance, in the case of a full crown preparation relative to the surfaces oriented toward the opposing dentition and in the case of an onlay preparation relative to the preparation floor, must be within a tolerance range of from 1.0 mm to 2.5 mm.

Advantageously, roughness indices of a preparation surface of the preparation can be determined and those subregions marked whose roughness indices lie outside a tolerance range centered about a preset desired roughness index.

The roughness indices may be defined, for example, as the average roughness, the quadratic roughness, or the average roughness depth. The roughness indices are determined indirectly by means of computer-aided methods from the optical, second 3D image and not directly on the preparation surface. The roughness indices are subsequently checked to determine whether they lie within a fixed tolerance range. This tolerance range is set such that the desired stability of a crown is guaranteed. If the subregions are too smooth, the adhesion of the dental cement for bonding the preparation to the crown is reduced, whereas subregions that are too rough at the restoration border result in a clinically intolerable inaccuracy of fit. The roughness indices of the preparation walls should be equal to at least 90% of the roughness indices of intact, uncarved tooth surfaces.

Advantageously, a roughness index can be determined on a surface of a healthy adjacent tooth to serve as a reference value for the determination of the roughness indices of the preparation surface.

A roughness index is obtained, prior to measurement, on a healthy surface of a tooth, such as the occlusal surfaces of the adjacent teeth, and is used as a reference value. This makes it possible to carry out at least relative measurement of the roughness in order to ascertain whether the subregions being examined are smoother or rougher than the surface of healthy, uncarved adjacent teeth.

A functional dependency in the form of a characteristic curve of the roughness indices obtained from evaluation of the optical, second 3D image and of the actual roughness can be experimentally determined so that the roughness indices can be allocated to an actual roughness value and any camera artifacts will not be interpreted as actual roughness. When carrying out an optical reference measurement on an uncarved, healthy tooth, the measured value acquired is compared with the known, actual roughness of healthy tooth surfaces.

Advantageously, a second distance, measured normal to the preparation surface of the fabricated preparation, can be determined between the preparation surface and the surface of a desired preparation and subregions can be marked whose second distance is outside the limits of a tolerance range.

By this means it is possible to check the extent to which the fabricated preparation deviates from the desired preparation. The desired preparation can have, for example, the form of a tangential preparation, a groove preparation, or a shoulder preparation. The user can select a desired type of preparation from a data base containing various 3D models of preparation types and can adapt the size thereof to the tooth to be prepared. The type of preparation is governed by the requirements concerning conservation of tooth substance, esthetic appearance, and stability. If the fabricated preparation deviates from the desired preparation, it will not be possible to satisfy these demands.

Advantageously, a third distance oriented normal to the axis of insertion can be determined between the preparation wall and the surface of the adjacent tooth, and subregions can be marked whose third distance is outside the limits of a tolerance range.

This makes it possible to check the necessary lateral material thickness of the therapeutic agent for achieving the necessary stability and the desired esthetic optical properties. Moreover, the third distance from the adjacent teeth necessary for the insertion of the therapeutic agent along the axis of insertion is checked.

The third distance for full crown, onlay, and inlay preparations should be at least 0.5 mm.

Advantageously, the preparation can have an axis of insertion. An angle between a preparation wall and the axis of insertion is determined in the cervical or in the mastical region. Subregions are then marked whose angles are outside a tolerance range centered about a fixed desired angle.

By this means, the fitting accuracy and stability of the restoration will be guaranteed, since subregions having an angle which is too acute or too obtuse could be the cause of reduced stability of the restoration. In the case of an angle which is too shallow, the cohesive friction contrary to the axis of insertion will be too small to support the adhesive action of the dental cement between the preparation and the crown to the required extent. In the case of an angle which is too steep, the shearing forces acting on the preparation walls will be too high to ensure nonproblematic insertion of the restoration for a precise fit of the end position of the restoration in the tooth. In the case of a full crown preparation, the angle for the mastical region directed toward the occlusal surface of the preparation or for the cervical region directed toward the tooth neck is determined. In the cervical region the desired angle is more acute than in the mastical region.

In the case of full crown preparations, the tolerance range of the angle lies between 4° and 9°. In the case of onlay and inlay preparations, this tolerance range is between 6° and 15°.

Advantageously, for determination of the angle, points are selected on an almost plane surface and linearly approximated.

By this means it is possible to set the alignment of the subregions in order to ascertain the angle. It is possible to select and linearly approximate more than two points. By this means, it is possible to determine an angle for subregions exhibiting unevenness, because the unevenness will be averaged out when many points are measured.

Advantageously, the points can be selected at a previously set distance from the preparation border parallel to the axis of insertion.

In this way the points can be automatically selected at defined intervals so that an objective assessment of different preparations is made possible.

Advantageously, the points can be automatically selected on an almost plane surface and linearly approximated by computer.

In this way manual selection of the points is unnecessary and the method of the invention is accelerated.

Advantageously, a fourth distance can be determined between subregions above the preparation border and the gingiva surface. Subregions above the preparation border are marked whose fourth distance is outside a tolerance range centered about a specific desired fourth distance.

This makes it possible to find subregions of the preparation which are too near to, or too far from, the gingiva surface. If the preparation border is too far from the gingiva surface, the transition between the prepared tooth and the synthetic crown can, due to differing coloration, be detrimental to the appearance of the dental prosthetic item. If the preparation border is too near to the gingiva surface, the bottom edge of the synthetic crown might cause inflammation of the gingiva.

In the case of full crown preparations, the fourth distance should give a so-called equigingival preparation profile having a tolerance range of from −0.2 mm to +0.2 mm or a supragingival gingiva profile showing a fourth distance of at least 0.2 mm. In the case of veneer preparations, the fourth distance should give a so-called subgingival preparation profile having a tolerance range of from −0.5 mm to −1.5 mm below the gingiva.

Advantageously, the subregions can be color marked with the color intensity increasing with the distance from the desired value within the limits of the respective tolerance range.

By this means the marked subregions, when displayed by means of a display device, such as a monitor, are high-lighted to attract the observer. The increase in color intensity within the tolerance range indicates the deviation from the desired value. Subregions showing the desired value are accordingly not marked.

Advantageously, the subregions can be color marked whose deviation from the desired value is outside the limits of the respective tolerance range.

By this means these subregions are clearly high-lighted and can be post-prepared accordingly.

Advantageously, a first 3D image can be produced from a plurality of images created from different directions. At least one of the images is created parallel to the axis of insertion of the preparation and serves as a reference image for setting up a coordinate system.

The alignment of the camera along the axis of insertion is made possible by way of a concurrent two-dimensional video image. The camera must be oriented until this 2D image has been acquired, for example for full crown preparations until the entire preparation border has been imaged, for onlay or inlay preparations until the entire preparation floor has become visible, or for veneer preparations until the entire labially carved tooth surface has been recorded.

A plurality of images from different directions is combined using graphics processing algorithms to form the second 3D image. One of the images can be created in the direction of the axis of insertion, and the axis of insertion can be automatically set, for example, as the Z-axis of a Cartesian coordinate system. If no image is created in the direction of the axis of insertion, an axis of insertion must be either fully automatically computed or set interactively in order to evaluate the images.

Advantageously, if a reference image parallel to the axis of insertion is not available, the axis of insertion must be set via the sum vector of single vectors extending parallel to the determined preparation walls.

A fully automatic computation of the axis of insertion is based on the identification, by the CAD system, of preparation walls and the identification of an occlusal surface of the preparation. The occlusal surface of the preparation is a plane which is parallel to the occlusal surface of an adjacent tooth or is parallel to the mean plane of two occlusal surfaces of the two adjacent teeth. The preparation walls are automatically segmented by the CAD system on the basis of edges and are represented by a single vector running parallel to the segmented preparation wall and the value of which is correlated with the surface area. All of the single vectors which are parallel to the occlusal surface of the preparation within the tolerance range of +/−30° are discarded. The remaining vectors are summated. The sum vector defines the computed axis of insertion of the preparation.

Advantageously, in the case of bridge preparations, the individual single vectors representing the walls of the preparation and provided for pillar teeth prepared for a crown are compared with each other.

By this means it is possible to detect parallel or diverging preparation walls automatically, which do not permit the use of a non-divided bridge restoration.

Advantageously, the correlation of the at least two 3D images can take place automatically by computer by the identification of at least one subregion of the adjacent tooth in at least two 3D images and superimposition thereof.

By this means there is no necessity for manual intervention in the correlating process and the method of the invention takes less time.

Advantageously, the correlation of the at least two 3D images can take place manually by the user selecting at least three similar points in the subregion of the adjacent tooth in the at least two 3D images and in bringing them into register.

If the automatic correlation does not provide the desired result, manual correlation is carried out, since the user will select distinctive similar points and the deviating subregions will, unlike the computerized process for such correlation, not be allowed for.

Advantageously, the preparation border of the preparation can be automatically detected in that a point on the preparation border is selected automatically or by the user and the remaining profile of the preparation border is determined by means of edge tracing.

This provides a starting point for a computer algorithm for edge tracing which automatically detects the profile of the preparation border.

The preparation can be prepared for a solid crown. In the case of a solid crown, all surfaces of the tooth are encased. These crowns usually consist of ceramic materials.

Different demands are placed on the full crown preparation and these must be satisfied to ensure the desired durability and the desired optical properties of the solid crown. These demands are checked according to the present invention, and subregions are marked whose parameters are outside the specified tolerance ranges.

The first distance is an interocclusal distance between that subregion of the preparation which faces the opposing dentition and the surface of the opposing dentition. The tolerance range of this distance is between 1.0 mm and 2.5 mm.

The preparation walls should be at an angle to the axis of insertion, the so-called preparation angle, which should be within a tolerance range of from 4° to 9°.

The preparation walls should be at a distance from the adjacent teeth of at least 0.5 mm. The full crown preparation may be a tangential preparation, a groove preparation, or a shoulder preparation. In the case of a tangential preparation, the desired preparation form shows a gradual transition between the carved preparation surface and the uncarved tooth. The advantage of this preparation form is the minimal removal of the dental enamel, but it suffers from drawbacks concerning the durability and fitting accuracy of the crown.

A groove preparation has a chamfer pointing to the opposing dentition, the radius of curvature and configuration of which is governed by the material and the shape of the grinder.

A shoulder preparation has a step-shaped recess at the preparation border as nearly at right-angles to the preparation walls as possible within a tolerance range of between 90° and 100°.

An onlay can be described as a solid crown, the preparation border of which is positioned directly below the occlusal surface such that the onlay covers the entire occlusal surface up to the cusp summits. The preparation border is disposed, predominantly on the vestibular and labial sides, at the level of the point of proximal contact with the adjacent teeth.

In the mesial and distal regions, a box broadening toward cervical is usually included in the preparation on account of frequently occurring proximal caries disposed between the teeth.

The two walls of a box should be configured to diverge conically, and its angle relative to the axis of insertion of the entire preparation should be within a tolerance range of from 6° to 15°.

The difficulty in making such an onlay preparation primarily resides in the relative measurement of the two walls of the mesial box relative to the two walls of the distal box. The four walls have to be prepared conically symmetrically to the axis of insertion of the total preparation so that the insertion axes of the distal and mesial boxes are as parallel as possible.

Onlays of ceramics may generally only be made with a shoulder or groove preparation, that is to say, a tangential preparation is unsuitable for this material.

Onlays of metal can also be made with a tangential preparation particularly in the region of proximal contact.

The two boxes in proximal positions are usually connected to an isthmus having a cone-shaped and box-shaped form and extending normal to the axis of insertion of the total preparation.

The tolerance ranges of the first distance and of the distance from the adjacent teeth, and the shape of the preparation border are for the various preparation forms the same as stipulated for a full crown preparation.

The preparation can also be prepared for an inlay. An inlay preparation is, unlike a full crown preparation, a defect-oriented preparation, that is to say, the extent of the preparation is predominantly governed by the extent of the previous caries, the filling, or the cavity.

As in the case of an onlay, if a cavity caused by caries or a filling is present in the region of proximal contact, it will be necessary to prepare a box showing cervical broadening.

The two walls of this box should diverge conically and should be at an angle to the axis of insertion of from 6° to 15°.

Advantageously, the inlay preparation can be broader than the onlay preparation, and a mesial and distal box can be prepared.

The difficulty in creating such an inlay preparation resides primarily in the relative measurement of the two walls of the mesial box to the two walls of the distal box. The preparation of the four walls must be conical and symmetrical to the axis of insertion, i.e. the insertion axes of the mesial and distal boxes should conform to the axis of insertion of the total preparation as far as possible.

Inlays of ceramics may generally only be created with a shoulder or groove preparation, that is to say, a tangential preparation is not suitable for this material.

Inlays of metal may, particularly in the region of proximal contact, also be created with a tangential preparation. Also, the edge in the proximal region may be prepared with a feather-edge margin, i.e. with a bevel.

If there is already present in the central masticatory region a cavity caused by caries or a filling, an isthmus, i.e. a cone-shaped cavity, is prepared.

In the case of an inlay, such an occlusal isthmus or cavity must show a minimum distance between the two opposing preparation walls, in order to achieve the required stability of the restoration. The minimum distance thus depends on the material to be subsequently used for fabrication of the inlay. This distance should be at least 1.5 mm.

In addition, a minimum distance of the preparation floor from the surface of the opposing dentition is necessary to acquire the necessary stability. This distance should be at least 1.5 mm.

In the case of an inlay of metal, the occlusal box (isthmus) should moreover show a bevel at an angle of 45° to the axis of insertion and a width between 0.5 mm and 1.0 mm.

The distance of the preparation walls from the adjacent teeth should, like the full crown preparation, be at least 0.5 mm.

By reason of dental demands for a defect-oriented design of an inlay preparation with the object of achieving minimal invasiveness, the present invention proposes that the cavity of the tooth be recorded in an optical 3D image, following the removal of caries-affected hard tooth tissue therefrom or following the removal of a dental filling. Using a computer-aided optimizing algorithm, there is calculated an inlay preparation adapted to satisfy two properties simultaneously. Firstly, the proposed inlay preparation must be dimensioned so as to be approximated to the prepared cavity as closely as possible, while secondly, however, the material-dependent minimum distances of the preparation walls in the occlusal isthmus region and also the distance of the preparation floor in the isthmus region must be allowed for. Then the user can use the determined optimal inlay preparation as a directive for creating the preparation.

This inlay preparation computed by means of an optimizing algorithm and thus ideally created now defines the desired master preparation, which serves for comparison with the inlay preparation actually created by the user, during which process subregions of the preparation from the first 3D image are marked which deviate from the desired master preparation.

Instead of the master preparation, use can, of course, be made of a desired preparation form designed by the user himself.

A veneer preparation generally has as starting position an intact anterior tooth with carious lesions or an anterior tooth fully restored with a filling.

The difficulty encountered with a veneer preparation consists substantially in that the intact labially oriented surface of the tooth must be subjected to removal of a layer of uniform thickness in order to satisfy the requirement of minimal invasiveness. The layer thickness, namely the distance of the labial preparation wall from the labial surface of the anterior tooth prior to preparation, should be between 0.3 mm and 0.8 mm.

The labial wall of a veneer preparation should consequently have the same curvature as the intact labial surface of the tooth prior to preparation.

Only when the tooth position is corrected by veneer shells is it possible to diverge from this requirement.

To achieve a veneer preparation configured for minimal invasiveness, the third optical 3D image includes the intact surface of the anterior tooth prior to preparation, and also the marginal gingiva line and the papilla.

Following a computer-aided optimizing procedure, an ideal veneer preparation having a uniform layer thickness and with a chamfer or an inwardly rounded shoulder is computed, which satisfies two demands simultaneously. Firstly, it is at a uniform distance from the intact, labial surface of the tooth prior to preparation, and secondly, an ideal preparation border is computed which runs along the gingiva line or below the gingiva line.

In the case of tooth position rectification or a computation of the preparation which does not satisfy the user, the user can himself plan a desired veneer restoration. The computed optimal veneer preparation or the desired veneer preparation set by the user defines a master preparation serve for comparison with the veneer preparation actually made by the user, in which case subregions of the preparation from the first 3D image are marked which deviate from the desired master preparation.

The preparation of a plurality of teeth can also be prepared for a bridge.

A bridge preparation complies with all of the demands placed on a full crown preparation for the preparation of individual teeth, as described above in detail.

For a bridge preparation there is an additional requirement. The preparation walls of each prepared pillar tooth are conical and define an axis of insertion of the respective pillar tooth. The preparation walls should consequently be at an angle to the axis of insertion of the total bridge preparation such that the insertion axes of the individually prepared pillar teeth are parallel to the axis of insertion of the total bridge preparation.

If this demand is not satisfied, there is no longer the assurance of a common axis of insertion and the integration of an undivided bridge is not possible.

This assessment of a bridge preparation is one of the most difficult tasks for the user and is often only objectively verifiable by making an impression and taking measurements with a parallelometer.

### BRIEF DESCRIPTION OF THE DRAWINGS

Exemplary embodiments of the invention are illustrated in the drawings, in which

FIG. 1 is a sketch of a tooth to be prepared and an opposing dentition,

FIG. 2 shows a first 3D image and a second 3D image,

FIG. 3 shows a second 3D image for determination of the preparation border,

FIG. 4 is a sectional view taken along the line AA in FIG. 3 correlated with the first 3D image in FIG. 2 for determination of a first distance,

FIG. 5 is a sectional view as in FIG. 4 for determination of a second distance,

FIG. 6 shows a detail of the sectional view shown in FIG. 4 for determination of an angle,

FIG. 7 is a 3D view of the sectional view shown in FIG. 4 for explanation of the CAD method used,

FIG. 8 is a sketch of the image created from three different directions,

FIG. 9a shows a third optical 3D image of the tooth prior to preparation,

FIG. 9b is a correlation of the first 3D image with the third 3D image,

FIG. 10 shows a first 3D image of an onlay preparation,

FIG. 11 shows a first 3D image of an inlay preparation,

FIG. 12 shows a first 3D image of a veneer preparation,

FIG. 13 shows a first 3D image of a bridge preparation,

FIG. 14 shows an implant with a full crown preparation.

### EXEMPLARY EMBODIMENTS OF THE INVENTION

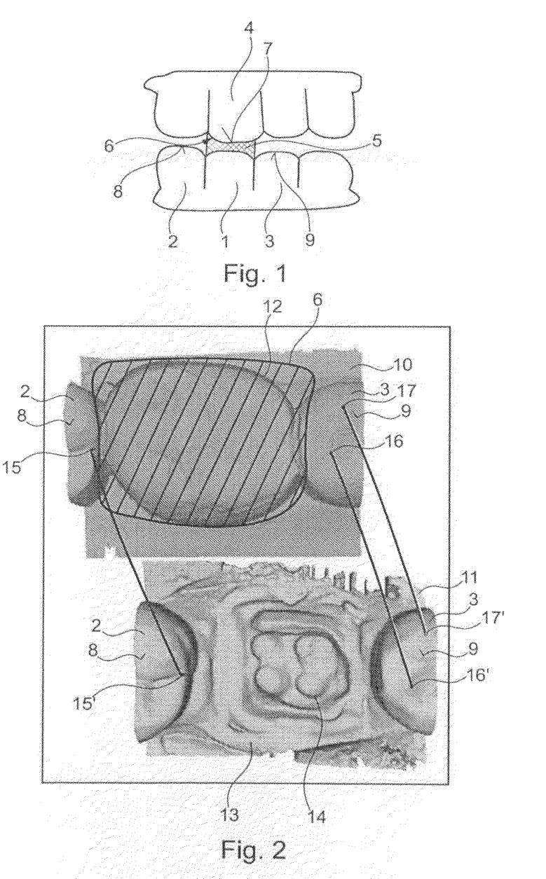

FIG. 1 illustrates a tooth 1 to be prepared with its adjacent teeth 2 and 3 prior to preparation. An impression compound 5 is positioned between the tooth 1 to be prepared and an opposing dentition 4. The patient bites on the molding compound 5 so that an impression 6 of the opposing dentition 4 having an occlusal surface 7 is produced at the site of the tooth 1 to be prepared. This impression 6 can also be created following preparation by putting the molding compound 5 between an already prepared tooth 1 and the opposing dentition 4. However, an impression 6 following preparation has the drawback that parts of the molding compound 5 could lead to impurities in a prepared tooth. The adjacent teeth 2 and 3 have occlusal surfaces 8 and 9.

FIG. 2 illustrates a first 3D image 10 and a second 3D image 11. The first 3D image 10 is obtained by optical recording of the impression 6 shown in FIG. 1 and of parts of the adjacent teeth 2 and 3. The impression 6 has an impression surface 12 representing the surface mating with the occlusal surface 7 of the opposing dentition 4 shown in FIG. 1. The impression 6 must be dimensioned such that the occlusal surfaces 8, 9 of the adjacent teeth 2, 3 remain uncovered as far as possible in order to be visible in the first image 10 for correlation purposes. The second 3D image 11 shows the prepared tooth 13 with its preparation 14 and parts of the adjacent teeth 2, 3 with their occlusal surfaces 8, 9. The second 3D image 11 was created following the removal of the molding compound 5 and after preparation. The first 3D image 10 is correlated with the second 3D image 11 by superimposing the coincident parts of the occlusal surfaces 8, 9 of the adjacent teeth 2, 3 in the two 3D images 10, 11. Correlation can take place automatically by means of a computer recognizing and superimposing said parts of the occlusal surfaces 8, 9. If the automatic correlation cannot take place because the occlusal surfaces 8, 9 are not recognizable as such, manual correlation is carried out. When manual correlation is carried out, at least three distinctive points 15, 16, and 17 on the occlusal surface 8 in the first 3D model 10 must be selected by a user who then selects three points 15′, 16′, and 17′ on the occlusal surface 9 of the second 3D model 11 which correspond to said points 15, 16, and 17. The points 15, 16, and 17 are caused to be in register with the points 15′, 16′, and 17′ so that correlation of the two 3D images 10, 11 is established.

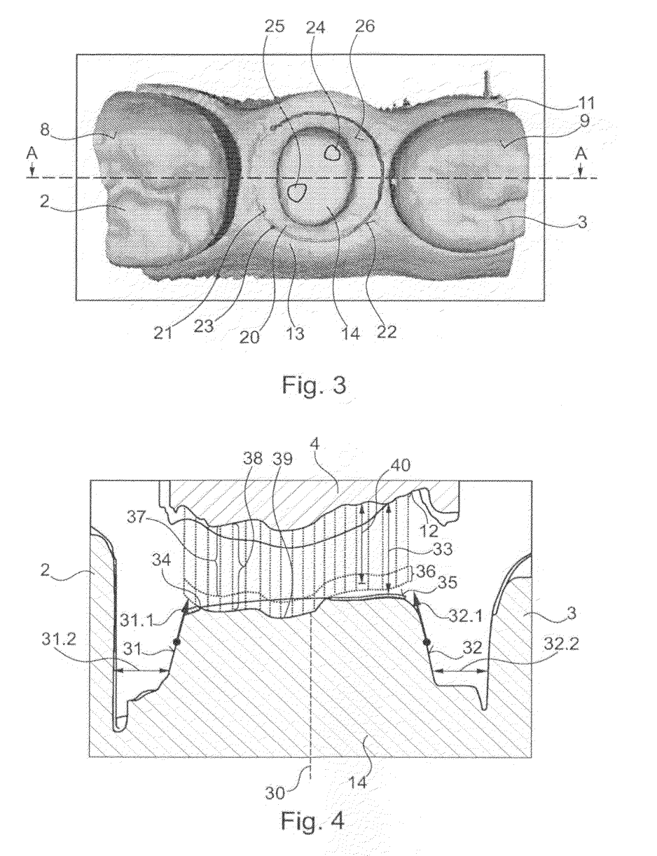

FIG. 3 shows the second 3D image 11 displaying the prepared tooth 13 and its adjacent teeth 2, 3 as shown in FIG. 2. The preparation 14 has a preparation border 20 separating the machined preparation surface 21 of the preparation 14 from the unmachined surface 22 of the prepared tooth 13. The preparation border 20 is manually or automatically determined from the second 3D image 11. In the case of manual determination, the preparation border 20 is marked by means of input means, such as a computer mouse. In the case of automatic determination, a point 23 on the preparation border 20 is selected by the user or automatically recognized by the computer program and, starting from this point 23, the rest of the preparation border 20 is determined by means of computerized edge tracing.

Moreover, the first 3D image 11 is used for checking the surface properties of the preparation 14, during which process the preparation 14 is examined for unevenness such as may result from imperfect grinding or the fact that the tooth to be prepared is seriously affected with caries. Roughness indices are determined for the preparation surface 21 by means of a computer-aided methods. Partial areas 24 having roughness indices exceeding the fixed tolerance range by a desired value of smoothness are marked red. Partial areas 25 having values below the tolerance range are marked green. Prior to measurement of the roughness, a roughness index of a healthy tooth surface such as on the occlusal surfaces 8, 9 of the adjacent teeth 2, 3 is determined to serve as a reference value for determination of the relative roughness.

The functional dependence of the roughness indices obtained from the first 3D image relative to the actual roughness is determined experimentally so that camera artifacts are not interpreted as actual roughness.

The roughness indices must be in a specific tolerance range, in order to ensure the stability of a crown to be accurately fitted to the preparation 14 and joined thereto by means of dental cement. When the subregions 25 and 31 and 32 shown in FIG. 4 are too smooth, there is reduced adhesion of the dental cement for joining the preparation 14 to the crown, whereas subregions of the preparation surface 21 at the restoration border that are too rough are the cause of clinically intolerable mismating. A roughness index is obtained, prior to measurement, on a healthy tooth surface, such as the occlusal surfaces 8, 9 of the adjacent teeth 2, 3, and is used as the reference value. This makes it possible to carry out at least one relative measurement of the roughness, in order to ascertain whether the examined subregions 24, 25, and 31, 32 shown in FIG. 4 are smoother or rougher than the surface of healthy adjacent teeth that have not been subjected to grinding.

The preparation border 20 is adjacent to preparation border areas 26. The preparation border areas 26 may not exceed a specific waviness, since a restoration border of a crown to mate with the preparation border areas 26 can only be produced up to a certain degree of waviness. A preparation border 20 exhibiting jags, for example, cannot be reproduced in a complementary manner. The preparation border areas 26 having a waviness outside a specific tolerance range are marked and can be post-ground for correction.

FIG. 4 is a sectional view taken along the line AA in FIG. 3 and showing the preparation 14 and its adjacent teeth 2, 3. The impression surface 12 from the first 3D image 10 shown in FIG. 2 is shown above the preparation 14. The impression surface 12 represents the occlusal surface of the opposing dentition 4 in place of the preparation 14. The preparation 14 has an axis of insertion 30 specified as the axis of symmetry of the lateral preparation walls 31 and 32. A matching crown will be mounted on the preparation 14 along this axis of insertion 30. A first distance 33 between an occlusal surface 34 of the preparation 14 and the impression surface 12 of the opposing dentition 4 is determined parallel to the axis of insertion 30. The first distance 33 can be automatically calculated by a computer.

The distance vectors for the distance 33 are all parallel to the axis of insertion (i.e. parallel to the Z-axis in the 3D coordinate system). Subregions 34 and 35 showing a first distance 33 greater than the specified tolerance range 36 comprising a minimum first distance 37 and a maximum first distance 38 are marked red. Subregions 39 showing a first distance 33 less than the specified tolerance range 36 with a minimum distance 37 and a maximum distance 38 are marked green. Within the tolerance range, the color intensity of the green is varied or coded according to its proximity to the interval limits 37 and 38. For example, the color intensity of subregions showing a first distance 33 within the tolerance range 36 can increase from the desired first distance 40 toward the boundary values 37, 38 of the tolerance range 36.

The tolerance range 36 is centered about a desired first distance 40 ensuring the stability of a crown joined to the preparation 14.

The position of the tolerance range 36 in the Z-direction is centered about a desired first distance 40 necessary for optimal mechanical stability and for desired optical properties of the crown.

The preparation walls 31 and 32 are at distances 31.2 and 32.2 from the adjacent teeth 2 and 3 respectively. Distances 31.2 and 32.2 that are too small lead to a small material thickness of the crown wall so that the demands regarding the stability and the esthetically optical properties of the crown will not be satisfied. Moreover, the intervals 31.2 and 32.2 must be large enough to make it possible to insert the crown along the axis of insertion 30. Consequently, an axis of insertion 30 that is inclined relative to the adjacent teeth 2 and 3 requires larger distances 31.2 and 32.2.

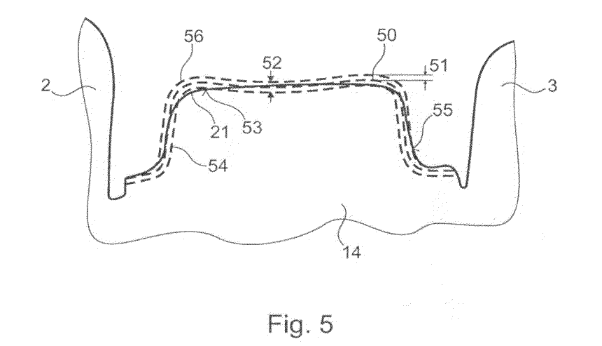

FIG. 5 is a sectional view of the finished preparation 14 and the adjacent teeth 2, 3 as shown in FIG. 4. A desired preparation 50 is at a second distance 51 from the finished preparation 14, this second distance 51 being measured normal to the preparation surface 21 of the preparation 14. Subregions of the preparation surface 21 at a second distance 51 outside a specified tolerance range 52 are color marked. Subregions 53 of the preparation surface 21 whose second distance 51 exceeds the first limit 54 of the tolerance range 52 toward the preparation 14 are marked red. Subregions 55 of the preparation surface 21 whose second distance 51 exceeds the second limit 56 of the tolerance range 52 away from the preparation 14 are marked green.

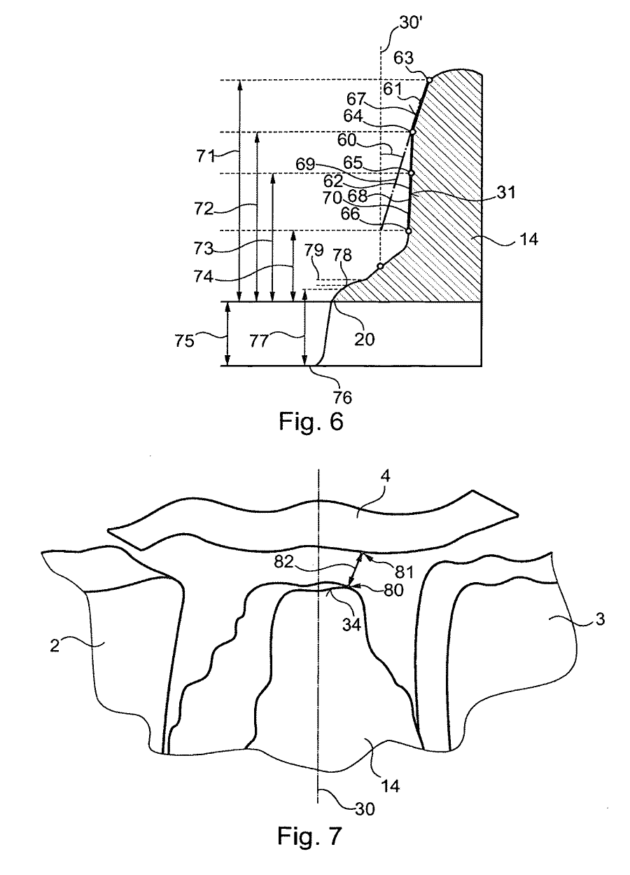

FIG. 6 shows a portion of the sectional view of the preparation 14 shown in FIG. 4 and involves the preparation wall 31. It illustrates a method step for checking an angle 60 between the preparation wall 31 and the axis of insertion 30. This method step takes place automatically in a computer. For reasons of clarity a line 30′ parallel to the axis of insertion 30 has been drawn. The angle 60 in a mastical region 61 directed toward the occlusal surface 34 and in a cervical region 62 directed toward the dental neck is determined by selecting, in a first, step, two points 63,64 and 65,66 respectively in each of substantially flat subregions 67 and 68 and subjecting them to linear approximation and, in a second step, measuring the angle 60 between said linear approximations 69, 70 and the axis of insertion 30. For such linear approximation, more than two points may be selected so that it is also possible to determine the alignment of an uneven surface. Subregions whose angles 60 are outside a tolerance range are marked red. The tolerance range contains a desired angle for the respective subregion 61 or 62. The points 63, 64, 65, and 66 are chosen at fixed intervals 71, 72, 73, and 74 of the preparation border 20, which are measured parallel to the axis of insertion 30. This makes it possible to provide, an objective rating of various preparations as regards the angle 60. The linear approximation is automatically carried out by computer.

Moreover, a further method step for checking a third distance 75 between the preparation border 20 and a gingiva surface 76 is illustrated. If the fourth distance 75 is smaller than the lower limit 77 of the specified tolerance range, the subregions 78 between the preparation border 20 and the lower limit 77 are marked red. Subregions having a third distance that is greater than the upper limit 79 are marked green.

FIG. 7 is a 3D view of the preparation 14 and the opposing dentition 4 shown in FIG. 4. The CAD method used makes it possible to select and display sectional views at arbitrary positions in the opposing dentition 4. Moreover, the CAD method used makes it possible to select points on displayed surfaces and to ascertain the distance between these points. In FIG. 7, a point 80 on the occlusal surface 34 and a point 81 on the impression surface 12 have been selected and marked red. A distance 82 between the points 80 and 81 has been determined and displayed as a blue line. Unlike the distance 33 shown in FIG. 4, the distance 82 is not parallel to the axis of insertion 30. In this way it is possible to manually check whether certain intervals are within their tolerance range. For example, the distance 51 of the preparation 14 from the desired preparation 50 shown in FIG. 5 and also the distance 33 shown in FIG. 4 can be manually checked.

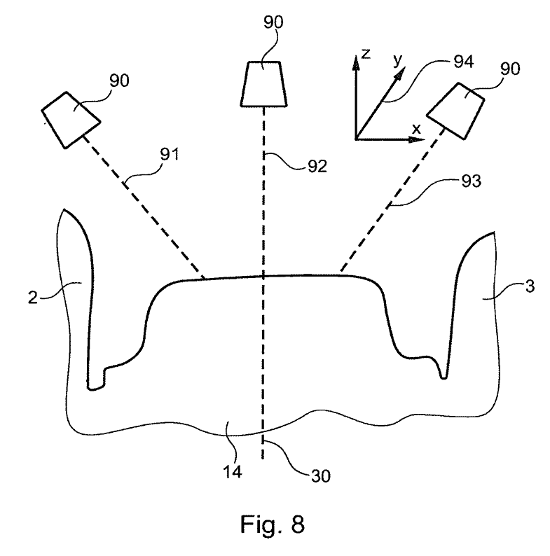

In FIG. 8, the second 3D image 11 of the preparation 14 and parts of the adjacent teeth 2, 3 is created in that an optical scanning device 90 produces images from three different directions 91, 92, and 93, which images are put together to form the second 3D image 11. One of the images is created in the direction 92 parallel to the axis of insertion and serves as a reference image for establishing a coordinate system 94. In this case, for example, the axis of insertion 30 can be defined as the Z-axis. If none of the images is created in the direction of the axis of insertion 30, the axis of insertion 30 must subsequently be fixed in the second 3D image 11, in order, for example, to make it possible to measure the first distance 33 shown in FIG. 4 along the axis of insertion 30.

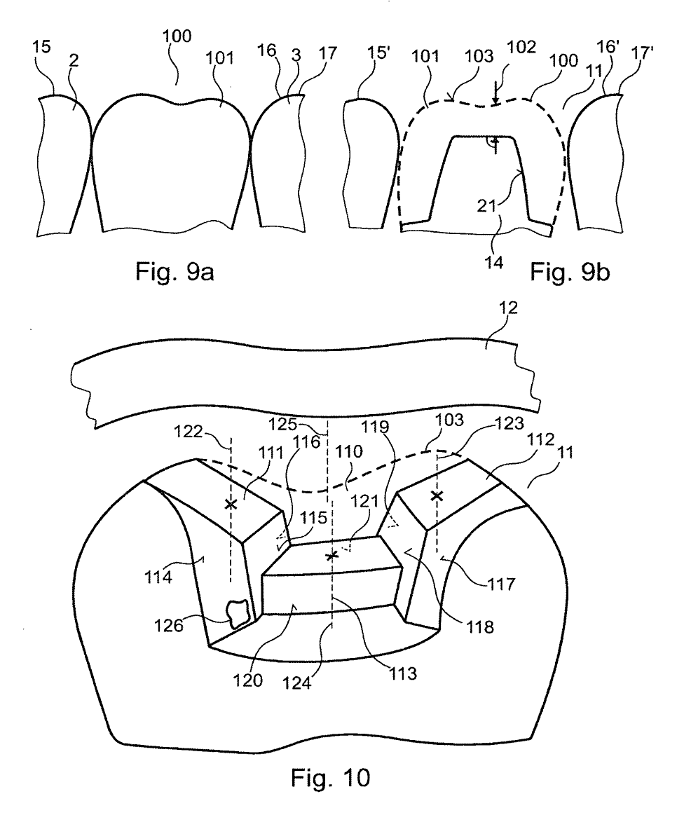

FIG. 9a shows a third optical 3D image 100 of the tooth 101 prior to preparation and also its adjacent teeth 2 and 3. The adjacent teeth exhibit distinctive points 15, 16, and 17.

FIG. 9b shows the first 3D image 11 of the prepared tooth 14, which has been brought into register with the third 3D image 100 shown in FIG. 9a using the coincident distinctive points 15′, 16′, and 17′. The thus correlated image consisting of the first 3D image 11 and the third 3D image 100 makes it possible to determine a distance 102 between the surface of the preparation 21 and the surface 103 of the tooth 101 prior to preparation, this distance 102 being determined normal to the preparation surface.

FIG. 10 shows a first 3D image of an onlay preparation 110, in which the first 3D image 11 and the second 3D image 10 of the impression of the opposing dentition shown in FIG. 2 is brought into register with the third 3D image 100 shown in FIG. 9a of the tooth prior to preparation thereof. The dashed line represents the surface 103 of the tooth 101 prior to preparation and the wavy plane represents the impression surface 12 of the opposing dentition shown in FIG. 4. The onlay preparation 110 comprises a distal box 111, a mesial box 112 and an occlusal box 113 (isthmus). The distal box 111 has preparation walls 114, 115, and 116. The mesial box 112 has preparation walls 117, 118, and 119. Furthermore, the occlusal box 113 (isthmus) has lateral preparation walls 120 and 121. The lateral preparation walls 114, 115, and 116 of the distal box 111 form an axis of insertion 122 of the distal box. The lateral preparation walls 117, 118, and 119 form the axis of insertion 123 of the mesial box, and the lateral preparation walls 120 and 121 form the axis of insertion 124 of the occlusal box. The preparation walls must be inclined such that the insertion axes 122, 123, and 124 of the distal box 111, the mesial box 112, and the occlusal box 113 coincide as far as possible making it possible to insert an onlay along a common axis of insertion. The angle of the lateral preparation walls 114, 115, 116, 117, 119, 120, and 121 relative to a common axis of insertion 125 can be within a tolerance range of from 6° to 15°. Subregions 126 of the onlay preparation whose angles to the common axis of insertion 125 are outside this tolerance range are marked.

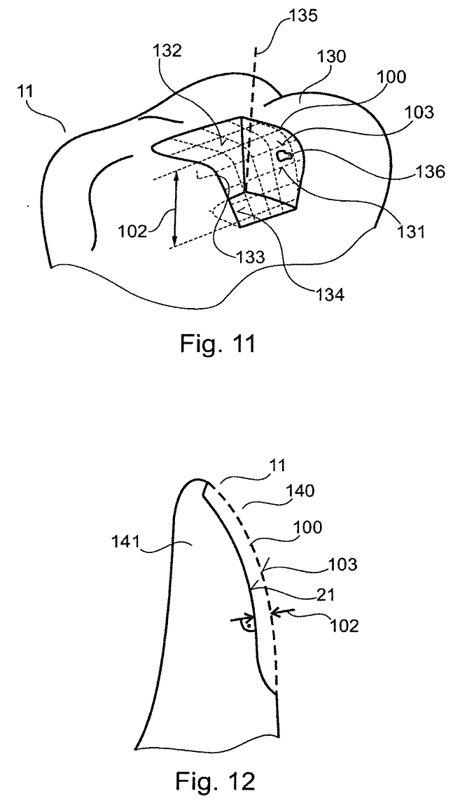

FIG. 11 shows the first optical 3D image 11 of a preparation 130 for an inlay. The inlay preparation 130 illustrated is on the labial side and has tapered preparation walls 131, 132, and 133. Moreover, the inlay preparation 130 has a preparation base 134. The first 3D image 11 of the inlay preparation 130 is correlated with the third image 100 of the tooth prior to preparation as shown in FIG. 9a and represented therein by a dashed grid. The lateral preparation walls 131, 132, and 133 form an axis of insertion 135 of the inlay preparation 130 and must be at an angle to this axis of insertion 135 which is within a tolerance value ranging from 6° to 15°. Subregions 136 whose angles are outside this tolerance range are marked. Another demand placed on the inlay preparation 130 is that the distance 102 between the preparation base 134 and the surface 102 of the tooth prior to preparation must be at least 1.5 mm. In the case of inlays of metal, the inlay preparation 130 must satisfy another demand, namely that the opposing preparation walls 131 and 133 must be separated by a distance of at least 1.5 mm.

FIG. 12 shows a first 3D image 11 of a preparation 140 for a veneer, which is correlated with a third 3D image 100 of an anterior tooth 141. The main requirement placed on the veneer preparation 144 is that the labial surface 103 of the anterior tooth 141 must be spaced from the preparation surface 21 by a distance 102 lying within a tolerance range of from 0.3 mm to 0.8 mm.

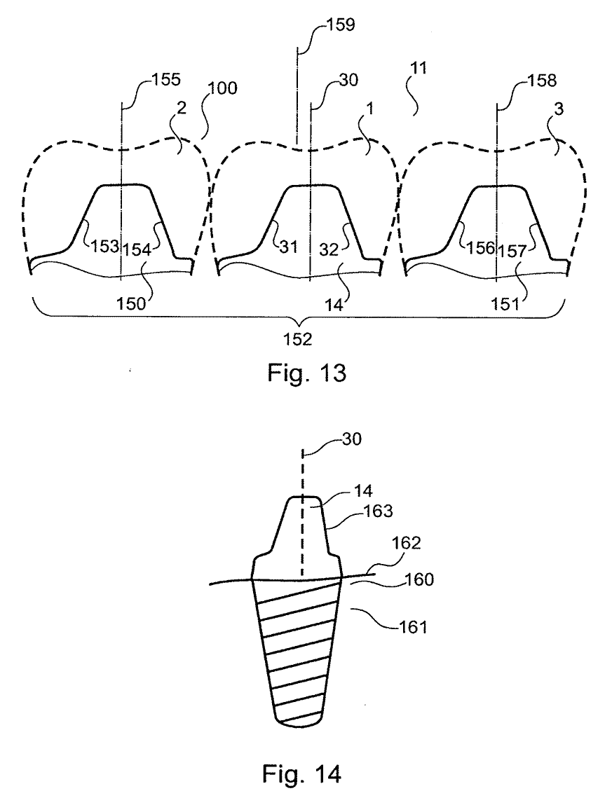

FIG. 13 shows a first 3D image 11 of the preparation 14 of the tooth 1, a second preparation 150 of the adjacent tooth 2 and a third preparation 151 of the adjacent tooth 3. The first 3D image 11 of the three preparations 14, 150, and 151 is correlated with the third 3D image 100 of the teeth 1, 2, and 3 prior to preparation, which third 3D image 100 is represented by dashed lines. The preparations 14, 150, and 151 together form a preparation 152 for a bridge. The individual preparations 14, 150, and 151 must satisfy the requirements placed on a full crown preparation, as explained with reference to FIG. 4 to FIG. 7. The preparation walls 31 and 32 of the full crown preparation 14 form an axis of insertion 30. The preparation walls 153 and 154 form an axis of insertion 155 of the full crown preparation 150 and preparation walls 156 and 157 form the axis of insertion 158 of the full crown preparation 151. A main requirement of the bridge preparation 152 is that the insertion axes 30, 155, and 158 of the individual preparations 14, 150, and 151 must be parallel to each other and to a common axis of insertion 159 of the bridge preparation 152. This makes it possible to insert an undivided bridge along a common axis of insertion 159.

FIG. 14 shows an implant 160 in a jawbone 161. An implant vertical extension 163 protruding above a gingiva surface 162 has a full crown preparation 14 such as shown in FIG. 3. The implant vertical extension 163 can be an adjacent separable from the implant or an inseparable extension of the implant. The full crown preparation 14 of the implant 161 has an axis of insertion 30. According to the present invention the illustrated preparation 14 of an implant 161 can be judged by the same criteria as are shown in FIG. 4 to FIG. 7.

### LIST OF REFERENCE NUMERALS OR CHARACTERS

1 tooth to be prepared
2 adjacent tooth
3 adjacent tooth
4 opposing dentition
5 molding compound
6 impression
7 occlusal surface
8 occlusal surface
9 occlusal surface
10 second 3D image
11 first 3D image
12 impression surface
13 prepared tooth
14 preparation
15, 16, and 17 distinctive points
15′, 16′, and 17′ corresponding three points
20 preparation border
21 preparation surface
22 unmachined surface
23 point
24 subregions
25 subregions
26 preparation border areas
30 axis of insertion
31, 32 preparation walls
31.1, 32.1 individual vectors
31.2, 32.2 third distance from the adjacent teeth
33 first distance
34 occlusal surface
35 subregions
36 tolerance range
37 minimum first distance
38 maximum first distance
39 subregions
40 desired first distance
50 desired preparation
51 second distance
52 tolerance range
53 subregions
54 first limit
55 subregions
56 second limit
60 angle
61 mastical region
62 cervical region
63, 64, 65, 66 points
67, 68 planar subregions
69, 70 linear approximations
71, 72, 73, 74 distances
75 fourth distance
76 gingiva surface
77 lower limit
78 subregions
80, 81 points
82 distance
90 scanning device
91, 92, and 93 directions
94 coordinate system
100 3D image
101 tooth
102 distance
103 surface of tooth 101
110 onlay preparation
111 distal box
112 mesial box
113 occlusal box
114, 115, and 116 lateral preparation walls of distal box 112
117, 118, and 119 lateral preparation walls of mesial box
120, 121 lateral preparation walls of occlusal box 113
122, 123, and 124 insertion axes
125 common axis of insertion
126 subregions
130 inlay preparation
131, 132, and 133 lateral preparation walls
134 preparation base
135 axis of insertion
136 subregions
140 veneer preparation
141 anterior tooth
144 veneer preparation
150 second preparation of adjacent tooth 2
151 third preparation of adjacent tooth 3
152 bridge preparation
153, 154 preparation walls
155 axis of insertion
156, 157 preparation walls
158 axis of insertion
159 common axis of insertion
160 implant
161 jawbone
162 gingiva surface
163 implant's vertical extension

1-24. (canceled)

25. A method for checking a preparation (14, 110, 130, 140, 152) of at least one prepared tooth (13) or at least one prepared implant (161) using CAD methods, utilizing a first 3D image (11) of the prepared tooth (13) or the prepared implant (161) including at least a portion of its adjacent tooth (2, 3), wherein a preparation border (20) of said preparation (14, 110, 130, 140, 152) is determined, an angle (60) of a preparation wall (31, 32) and/or the roughness of said preparation (14, 110, 130, 140, 152) are determined, those subregions (24, 25, 53, 55, 78) of said preparation (14) are marked whose angle (60) and/or whose roughness are outside the limits (54, 56, 77, 79) of a respective tolerance range (52) and/or those preparation border areas (26) which adjoin said preparation border (20) are marked whose waviness is outside a tolerance range, wherein said preparation (14) has an axis of insertion (30) and that an angle (60) between a preparation wall (31, 32) and said axis of insertion (30) in the cervical or mastical region (61, 62) is determined, and those subregions (78) are marked whose angle (60) is outside a tolerance range centered about a specific desired angle, wherein at least one of said images is created parallel to an axis of insertion (30) of said preparation (14) and serves as a reference image for establishing a coordinate system (94), wherein in the absence of a reference image parallel to the axis of insertion (30) said axis of insertion (30) is determined via the sum vector of single vectors (31.1, 32.1) extending parallel to the determined preparation walls (31, 32), wherein said first, second, and/or third 3D image (11, 11, 100) are created intraorally in an oral cavity of a patient or phantom head.

26. The method as defined in claim 25, wherein for the purpose of checking said preparation (14, 110), a second 3D image (10) of an impression (6) of the opposing dentition (4) at the position of said prepared tooth (13) or said prepared implant and of at least a portion of an adjacent tooth (2, 3) is used, said first 3D image (11) is brought into register with said second 3D image (10), from said correlated 3D images (10, 11) there is determined a first distance (33) of said preparation (14, 110) of said prepared tooth (13) from the opposing dentition (4) and those subregions (35, 39) of said preparation are marked whose first distance (33) from the opposing dentition (4) is outside the limits (37, 38) of a tolerance range.

27. The method as defined in claim 25, wherein for the purpose of checking the preparation (14, 140) a third 3D image (100) of the tooth (101, 141) to be prepared created prior to preparation and at least part of an adjacent tooth (2, 3) is used, said first 3D image (11) is brought into register with said third 3D image (100), from the thus correlated 3D images (100, 11) a distance (102) from the preparation (14, 140) from the surface (103) of said tooth (101, 141) prior to preparation normal to the surface (21) of said preparation (14, 140) is determined, and those subregions of said preparation are marked whose distance from said tooth (101, 141) prior to preparation is outside the limits of a tolerance range.

28. The method as defined in claim 25, wherein the subregions (24, 25, 53, 55, 78, 126, 136) of said preparation (14, 110, 130, 140, 152) which are outside the limits (54, 56, 77, 79) of a respective tolerance range (52) are automatically marked by computer.

29. The method as defined in claim 25, wherein the waviness of the preparation border areas (26) adjoining the preparation border (20) is determined and those preparation border areas (26) are marked whose preparation border (20) exhibits jags.

30. The method as defined in claim 25, wherein said preparation (14, 110) has an axis of insertion (30, 125) and a first distance (33) of an occlusal surface (34) of said preparation (14, 100) from the impression surface (12) of said opposing dentition along the axis of insertion (30, 125) is determined and those subregions (35, 39) are marked whose first distance (33) is outside a tolerance range (36) centered about a specific desired first distance (40).

31. The method as defined in claim 25, wherein roughness indices of a preparation surface (21) of said preparation (14, 110, 130, 140, 152) are determined and those subregions (24, 25) are marked whose roughness indices are outside a tolerance range centered about a specific desired roughness index.

32. The method as defined in claim 25, wherein a roughness index of a surface (8, 9) of a healthy adjacent tooth (2, 3) is determined to serve as a reference value for determination of the roughness indices of said preparation surface (21).

33. The method as defined in claim 25, wherein a second distance (51) normal to the preparation surface (21) of the finished preparation (14, 110, 130, 140, 152) is determined between said preparation surface (21) and the surface of a desired preparation (50), and those subregions (53, 55) are marked whose second distance (51) is outside the limits (54, 56) of a tolerance range (52).

34. The method as defined in claim 25, wherein a third distance (31.1, 32.2) normal to said axis of insertion (30) is determined between the preparation wall (31, 32) and the surface of the adjacent tooth (2, 3), and those subregions are marked whose third distance (31.1, 32.2) is outside the limits of a tolerance range.

35. The method as defined in claim 25, wherein for determination of said angle (60) of the preparation wall (31, 32) points (63, 64, 65, 66) on an approximately plane surface (67, 68) are selected and linearly approximated.

36. The method as defined in claim 35, wherein said points (63, 64, 65, 66) are selected at a previously set distance (71, 72, 73, 74) from said preparation border (20) parallel to said axis of insertion (30).

37. The method as defined in claim 36, wherein said points (63, 64, 65, 66) are automatically selected on an approximately plane surface (67, 68) and linearly approximated by computer.

38. The method as defined in claim 25, wherein a fourth distance (75) is determined between subregions above the preparation border (20) and the gingiva surface (76), and those subregions (78) above the preparation border are marked whose fourth distance (77) is outside the limits (77, 79) of a tolerance range centered about a specific desired fourth distance.
